(19) United States
(12) Patent Application Publication
(10) Pub. No.: US 2003/0103277 A1
(43) Pub. Date: Jun. 5, 2003

(54) Imaging device with angle-compensated focus

(76) Inventor: Clifford A. Mohwinkel, San Jose, CA (US)

Correspondence Address: Ingrid McTaggart, 702 S.E. 5th Ave, Hillsboro, OR, 97123, US

(21) Appl. No.: 10/010,527

(22) Filed: Dec. 5, 2001

(51) Int. Cl. G02B 21/02; G02B 7/02

(52) U.S. Cl. 359/811

(57) ABSTRACT

An optical device, typically including an image receiving device such as a charged coupled device (CCD) array and an objective lens, is positioned oblique to an object plane. The optical device ensures that the plane of the image receiving device, the plane of the object lens, and the object plane all intersect along a common line such that the entire object plane is in focus on the image receiving device. The positions of the image receiving device, the objective lens and/or the object plane can be manually or automatically adjusted. The invention is useful to obtain an enlarged, focused image of a work piece that is disposed in a plane transverse, but not perpendicular, to the viewing axis of the optical device.

### 1. TECHNICAL FIELD

The present invention relates to an imaging device with angle-compensated focus and, more particularly, to an imaging device including a movable image receiving device, such as a video camera or a microscope, and a movable objective lens that provide compensation for focusing an entire object plane that is disposed oblique to an optical axis of the imaging device.

### 2. DESCRIPTION OF RELATED ART

In a conventional video camera, a charged-coupled device (CCD) array typically is disposed in a plane perpendicular to the viewing axis of the camera and parallel to the object plane of the work piece under inspection. In this arrangement, the entire work piece typically is in focus at one time. However, when viewing a work piece disposed in a plane transverse to but not perpendicular to the camera viewing axis, the depth of field of the viewing plane generally is so small that only a narrow strip of the work piece is in focus. Accordingly, oblique angles typically have been utilized to view only a small portion of a work piece under inspection.

One prior art device, disclosed in U.S. Pat. No. 5,253,106 to Hazard, discloses an oblique viewing system for a microscope which provides perpendicular and oblique views of a surface under inspection. However, the system only allows a small portion of the work piece to be in focus at any given time. The system includes a folding mirror and an oblique viewing mirror spaced from the folding mirror and having its reflecting surface facing the object under inspection. The folding mirror can be set in a first stowed position so as to allow viewing of the object along an optical axis perpendicular to the plane of the object, and a second, extended position so as to allow viewing of the object along an oblique angle with respect to the plane of the object. Hazard discloses an elaborate support system to ensure that the oblique mirror maintains approximately the same optical path from the surface of the object under inspection to the microscope, over a range of oblique viewing angles. In other words, the structure appears to ensure that the mirror pivots about the object being viewed so that the individual object will remain in focus regardless of the position of the mirror. This prior art device allows only one object, i.e., only a portion of the work piece and not the entire plane of the work piece, to be in focus at any particular time. Moreover, the lens system is positioned perpendicular to the object being viewed.

Another prior art device, U.S. Pat. No. 5,052,789 to Kleinberg, discloses a multi-user microscope with an orientation adjustment mechanism that provides primary and secondary viewing stations that simultaneously show the same image. In the lens system disclosed, the binocular of the assistant is maintained parallel to the image viewed by the primary viewer. Kleinberg does not disclose a device where a CCD array or an objective lens is tilted at an angle oblique to the perpendicular axis of the work piece so as to allow focus along an entire CCD array. Moreover, the viewing device of Kleinberg is positioned perpendicular to the object being viewed.

These prior art devices will only function if their objective lens is positioned along the axis perpendicular to the object plane. These devices, therefore, would be useless to provide focused viewing of a work piece in situations where another device is positioned along the perpendicular axis of the work piece, such as a die bondhead or the like. Moreover, these prior art devices do not allow for focus of an entire object plane when the object is viewed from an angle oblique to the plane of the work piece.

Accordingly, it would be desirable to provide an imaging device wherein the device is positioned at an oblique angle with respect to the object being viewed, yet which provides the entire object plane in focus (within the covering power limits of the lens), not merely a portion thereof.

### SUMMARY OF THE INVENTION

The invention comprises an imaging device having an adjustment mechanism for focusing on an object disposed in a plane that is oblique to an optical axis of the imaging device. The adjustment preferably is achieved by adjusting the angle of a charged-coupled device (CCD) array, or any receiving device for imaging, relative to the optical axis so that the plane of the receiving device, the plane of the objective lens and the plane of the object being viewed all intersect at a single line. In particular, along with bringing the object into focus according to the intent of the present invention, changing the angle of the CCD array changes the perspective of the image and changing the angle of the lens changes the focal length and magnification of the image. In one embodiment, both the CCD array and the objective lens are each moved to view the entire plane of the work piece in focus. In another embodiment, only one of the imaging receiving device or the objective lens is moved to view the entire plane of the work piece in focus.

The invention is useful to obtain an enlarged, focused image of a work piece that is disposed in a plane transverse to, but not perpendicular to, the viewing axis of the imaging device. This particularly happens when integrated circuit chips are being manipulated prior to and during placement on a circuit board. In such situations, there may be a device, such as a bondhead, that works along the axis perpendicular to the work piece plane. It may be necessary, therefore, to position the optical observation device, such as a video camera or a microscope, at a non-perpendicular angle to the plane of the work piece.

By tilting the CCD array, the objective lens, or both, to produce a plane of focus that is coincident with the plane of the CCD, it is found that there is an angle of tilt of the array at which the image of the work piece is in focus along the entire array. Accordingly, the present invention provides an imaging device wherein the device is positioned at an oblique angle with respect to the object being viewed, and which provides the entire object plane in focus (within the covering power limits of the lens), not merely a portion thereof. Moreover, by rotating the object plane about its perpendicular axis, relative to the imaging system, the object plane can be viewed from any direction.

In particular, the present invention includes an imaging system comprising: an object plane that defines an object plane axis perpendicular to said object plane; an image receiving device positioned oblique to said object plane axis; a lens positioned oblique to said object plane axis, wherein said image receiving device and said lens are each positioned with respect to said object plane axis such that the entire object plane is in focus on said image receiving device, and wherein said image receiving device is chosen from the group consisting of an electronic image receiving device and a microscope. The invention further includes a method of focusing an entire object plane, comprising the steps of: providing an image receiving device along an optical axis positioned oblique to an object plane, wherein said image receiving device is chosen from the group consisting of an electronic image receiving device and a microscope; providing a lens along said optical axis; positioning said image receiving device so that a display plane of said image receiving device intersects said object plane at a sheimpflug line, and positioning said lens so that a lens plane of said lens intersects said object plane at said sheimpflug line, such that the entire object plane is in focus on said image receiving device. The invention also includes an optical device comprising: an image image receiving device adjustably positioned along an optical axis oblique to a line positioned perpendicular to an object plane; and a lens adjustably positioned along said optical axis, wherein said image image receiving device is chosen from the group consisting of an electronic image receiving device and a microscope.

Accordingly, it is an object of the present invention to provide an imaging device that is positioned at an oblique angle with respect to a line positioned perpendicular to an object being viewed.

It is another object of the present invention to provide an imaging device positioned at an oblique angle with respect to a line positioned perpendicular to an object being viewed wherein the entire object plane is in focus, and not merely just a portion thereof.

It is a further object of the present invention to provide an imaging device wherein a charged-coupled device (CCD) array is adjustably positioned at an oblique angle to the optical axis, and wherein an objective lens is adjustably positioned at an oblique angle to the optical axis, so as to produce a plane of focus of the object plane coincident with the plane of the CCD array.

It is still another object of the present invention to provide an imaging system wherein an object plane can be viewed from any direction around an axis perpendicular to the object plane.

### BRIEF DESCRIPTION OF THE DRAWINGS

FIG. 1 is an isometric view of one embodiment of the imaging device of the present invention positioned at an oblique angle with respect to a line positioned perpendicular to an object plane.

FIG. 2 is an isometric view of the imaging device of FIG. 1 wherein the position of the imaging device with respect to the perpendicular axis of the object plane has been adjusted.

FIG. 3 is a cross sectional side view of one embodiment of the imaging system.

FIG. 4 is an isometric view of a CCD array and an objective lens each positioned at an oblique angle with respect to a perpendicular axis of an object plane wherein the entire object plane will not be in focus.

FIG. 5 is an isometric view of the device of FIG. 4 wherein the position of the CCD array and the objective lens with respect to the perpendicular axis of the object plane have been adjusted so that the entire object plane will be in focus.

FIG. 6 is an isometric view of the device of FIG. 5 wherein the CCD array and the objective lens have been rotated and their angle adjusted with respect to an axis normal to the object plane and wherein the entire object plane will be in focus.

FIG. 7 shows the image displayed on the CCD array of FIG. 4, wherein only a portion of the object plane is in focus.

FIG. 8 shows the image displayed on the CCD array of FIG. 5, wherein the entire object plane is in focus, due to the angle-compensated adjustment capabilities of the present invention.

FIG. 9 shows the image displayed on the CCD array of FIG. 6 wherein the object plane is viewed from a different angle from the view shown in FIG. 8.

FIG. 10 shows an alternative embodiment of the alignment device for the charged coupled device array.

FIG. 11 shows an alternative embodiment of the alignment device for the objective lens.

### DETAILED DESCRIPTION OF THE PREFERRED EMBODIMENTS

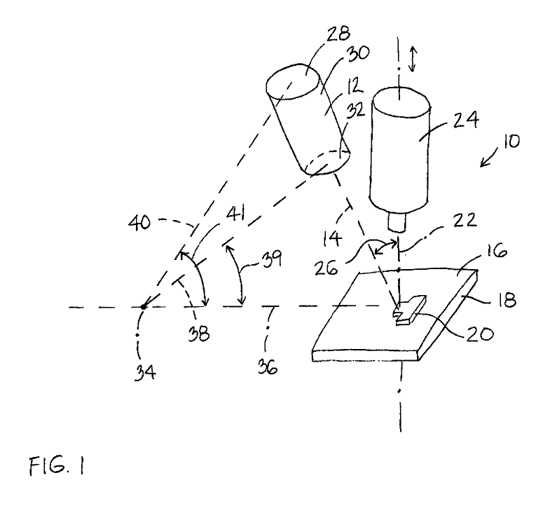

FIG. 1 shows an isometric view of the imaging system 10 of the present invention including an optical device 12 positioned along an optical axis 14 so as to view an object plane 16. In the preferred embodiment optical device 12 includes an image receiving device, such as charged coupled device array or a microscope, and an objective lens, as will be discussed in more detail below. A work piece 18, including a discrete object 20, typically is positioned coincident with object plane 16. The present invention typically will be used to focus on a plane of view. Accordingly, the work being viewed by the system of the present invention typically will comprise a generally planar work piece or a three-dimensional work piece wherein the system is used to focus on a single plane of the three-dimensional work piece. Discrete object 20 may comprise, for example, a bonding pad 20 positioned on a circuit board 18. Object plane 16 defines a perpendicular axis 22 extending through the work piece or object being viewed. A bondhead 24, or other such device, may be positioned along perpendicular axis 22 so as to place and bond a die (not shown) on bonding pad 20. Due to the presence of bondhead 24 (which comprises no part of the present invention), optical axis 14 of optical device 12 is positioned at an oblique angle 26 with respect to perpendicular axis 22. Of course, the optical device may be positioned at an oblique angle for a variety of reasons, irrespective of the presence or absence of a bondhead. By the term oblique angle Applicants mean an angle greater than zero degrees and less than ninety degrees. However, Applicants believe that the best performance of the imaging device is achieved at small oblique angles, i.e., angles that are close to the axis perpendicular to the work piece. In particular, as the angle of the optical device is increased, as measured from the perpendicular axis, the depth of field decreases and lens aberration and vignetting occur. In other words, angles of greater than zero degrees and less than sixty degrees, as measured from the perpendicular axis, are believed to result in the best performance of the device. In a conventional imaging system, placement of an optical device at an oblique angle to the perpendicular axis of the work piece would result in only a portion of the work piece being in focus at any given time. The present invention provides, however, an adjustment mechanism that allows the entire work piece to be in focus when the optical device is positioned at an oblique angle with respect to the perpendicular axis of the work piece.

Still referring to FIG. 1, optical device 12 typically includes an imaging region 28 which may include an image receiving device or an electronic image receiving device, such as a charged-coupled device (CCD) array or a microscope, a main body 30 and a lens 32, each positioned along optical axis 14, wherein optical axis 14 and axis 22 define oblique angle 26 therebetween. In the preferred embodiment shown in this figure, the CCD array, the main body and the lens are all shown positioned within a single optical tube. In other embodiments, the CCD array and the objective lens may be positioned separate from one another, i.e., not both contained within a single main body portion.

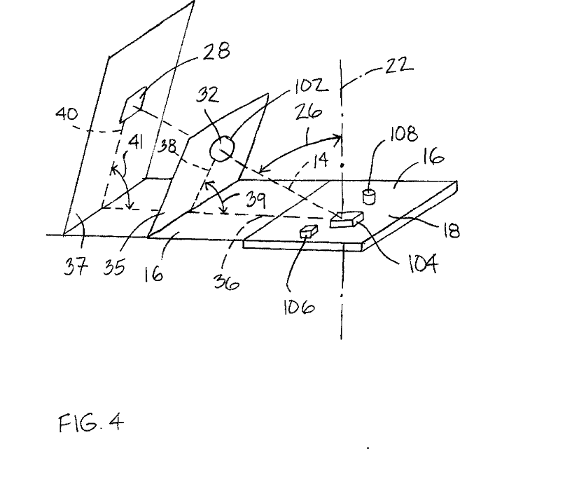

CCD array 28 and lens 32 are structured so as to pivot about one of an infinite number of Sheimpflug lines 34 (Sheimpflug line 34 is shown in end view as a point in this figure). As will be understood by those skilled in photographic arts, the existence of a Sheimpflug point, i.e., the intersection of three axes, is known. However, the present invention provides for focusing capabilities by ensuring that three planes, as opposed to three lines, all intersect along a single line, which Applicant refers to herein as a “Sheimpflug line”, i.e., the intersection of the axis of the work piece, the axis of the image receiving device and the axis of the lens. Applicant's Sheimpflug line generally extends through the Sheimpflug point and represents the intersection of the three above listed planes. In particular, objective lens 32 defines an axis 38 that is positioned parallel to and extends through the plane 35 (FIG. 4) of objective lens 32. CCD array 28 defines an axis 40 that is positioned parallel to and extends through the plane 37 (FIG. 4) of CCD array 28. Sheimpflug line 34 may be positioned anywhere along any axis 36 extending through object plane 16, wherein Sheimpflug line 34 is defined as the intersection of the plane 16 (more clearly shown in FIG. 4) containing axis 36 of the object plane, the plane 35 (FIG. 4) containing axis 38 of objective lens 32, and the plane 37 (FIG. 4) containing axis 40 of CCD array 28. In other words, accordingly to Sheimpflug's principle, if the plane of the work piece, the plane of the objective lens and the plane of the CCD array all intersect along a single line, then the entire work piece will be in focus on the CCD array. The present invention provides structure to insure this intersection of the three planes occurs for a variety of different positions of the optical device. Accordingly, when the focusing dial is adjusted accordingly, the work piece can be viewed from a variety of locations while the optical device retains the entire work piece in focus.

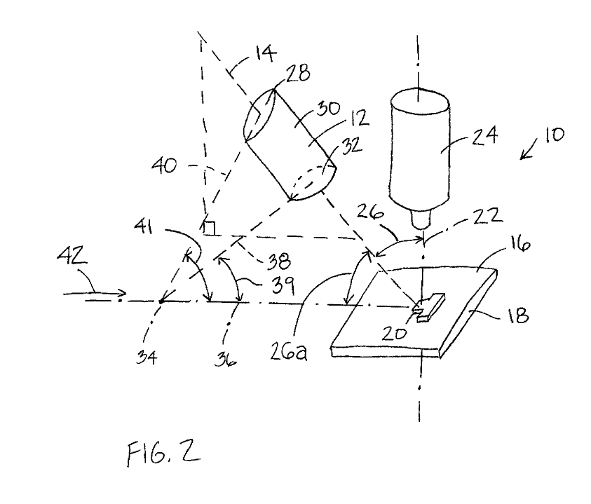

FIG. 2 is an isometric view of the optical device of FIG. 1 wherein angle 26 of optical device 12 with respect to object plane 16 has been adjusted. In particular, main body 30 has been moved so that Sheimpflug line 34 has been moved in direction 42 along axis 36 toward work piece 18. Optical axis 14 has been shifted upwardly, i.e., angle 26 had been decreased. In another way of describing the movement, oblique angle 26a between axis 14 and axis 36 has been increased. Additionally, the angle 39 defined between axis 38 and the horizon, and the angle 41 defined between axis 40 and the horizon (represented by axis 36 of the work piece), have both been increased, compared to the corresponding angles 39 and 41 of FIG. 1. In other words, the angle of the lens and the CCD array have been changed in order to maintain a coincidence of the planes of the CCD array, the lens and the object being viewed.

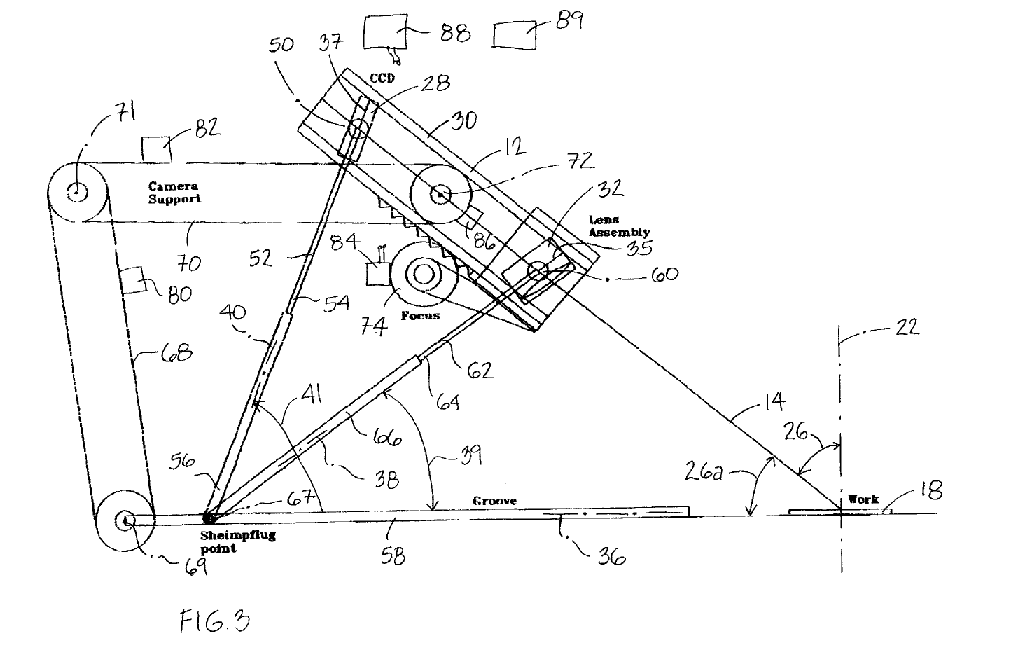

FIG. 3 shows a cross sectional side view of one embodiment of optical device 12. Main body 30 is shown including video image receiving device 28, such as a CCD array, and lens assembly 32. CCD array 28 is pivotally connected within main body 30 at a pivot point 50, and is connected to a first end 52 of telescoping member 54, wherein a second end 56 of telescoping member 54, also called an alignment device, is secured within a track 58 aligned with axis 36. The image receiving device is secured to member 54 such that the plane 37 of the image receiving device is always aligned and coincident with axis 40 which extends along the alignment member. Similarly, lens assembly 32 is pivotally connected within main body 30 at a pivot point 60, and is connected to a first end 62 of telescoping member 64, also called an alignment device, wherein a second end 66 of telescoping member 64 is secured within track 58. The lens is secured to member 54 such that the plane 35 of the image receiving device is always aligned and coincident with axis 38 which extends along the alignment member. Second end 56 of telescoping member 54 and second end 66 of telescoping member 64 are connected together at a common pivot point 67 within track 58. Pivot point 67 is movable along track 58 as main body 30 of the optical device is moved. Each of the positions of pivot point 67 along the track defines a Sheimpflug line 34. Moreover, track 58 may be rotated about perpendicular object plane axis 22 so that the object plane may be viewed from any direction. In addition to pivotal movement of imaging device 28 and lens assembly 32 about axis 22 and about pivot point 67, also referred to as tilt movement, imaging device 28 and lens assembly 32 are each movable, i.e., shiftable, along axes 40 and 38, respectively, and are each rotatable about axes 40 and 38, respectively, also referred to as swing movement.

Optical device 12 further comprises a first camera support arm 68 pivotally connected at a first end to track 58. First support arm 68 is pivotally connected at its opposite end to a first end of a second camera support arm 70. Second camera support arm 70 is pivotally connected at its opposite end to main body 30 of the optical device so as to define a pivot point 72. Main body 30 also comprises a focusing device 74 such as a focus knob. In operation, camera support arms 68 and 70, and pivot point 72, are used to position main body 30 in a desired orientation with respect to work piece 18 (FIG. 1). Main body 30 of the optical device is aligned, by retraction or extension of telescoping arms 54 and 64, such that optical axis 14 is aligned with work piece 18. Focus knob 74 is then used to move the objective lens assembly 32 along main body 30 and along axis 14 so as to focus the lens on the work piece. By securing the lower ends of telescoping arms 54 and 64 together in track 58 which is aligned with axis 36, by ensuring that the plane 37 of CCD array 28 is aligned with axis 40 of telescoping arm 54, and by ensuring that the central plane 35 of objective lens 32 is aligned with axis 38 of telescoping arm 64, the structure disclosed ensures that the planes defined by the work piece, the CCD array and the lens assembly all intersect at and define a particular location for the Sheimpflug line, as shown in end view as point 34. Accordingly, the entire work piece, and not just a narrow section thereof, will be in focus on CCD array 28.

Movement of the camera support arms, the main body of the optical device and the focusing knob may be accomplished by manual operator manipulation, by motors coupled to sensors and/or pattern recognition systems or other such software, by any other such manual or motorized means, or by any combination thereof. In particular, in one embodiment, arm 68 includes a motor 80 (shown schematically) which pivots arm 68 about a pivot point 69 on track 58. Arm 70 includes a motor 82 which pivots arm 70 about a pivot point 71 on arm 68. Focusing device 74 includes a motor 84 which extends and retracts lens assembly 32 along axis 14 with respect to main body 30. Main body 30 includes a motor 86 that pivots the main body about a pivot point 72 on camera support arm 70. Each of the motors are shown schematically for ease of illustration. Applicants note that the manual or automatic motor controlled movement of the support arms, and the corresponding alignment function of the alignment rods, function to ensure coincidence of the CCD array plane, the objective lens plane and the object plane so that the entire object plane will be in focus on the CCD array, so long as the device is properly focused. Additional motor or manual manipulation may be conducted to focus the device by manipulating the focusing knob, as will be understood by those skilled in the art, and as described below.

In this particular embodiment, the focus knob 74 may be connected to a pattern recognition system 88. Pattern recognition system 88 may include positioning sensors and may be operatively connected to motor 84 such that the system is automatically manipulated to move the optical device into focus on the work piece. In particular, the motor may control movement of the objective lens along the optical device to focus the device, wherein the support arms and the alignment rods may be separately moved to ensure coincidence of the imaging, lens and object planes. Accordingly, the structure of the present invention may be operated manually or automatically to display an image including a focused image of the entire work piece under observation, and not merely a focused image of only a narrow section of the work piece.

In another embodiment, the alignment rods shown in FIG. 3 may not be present at all. Instead, the motors of the support arms may be controlled by sensors, software or the like, so as to ensure that the plane of the CCD array, the plane of the objective lens and the plane of the object being viewed are coincident at a sheimpflug line. In such an embodiment, a computer system 89 may be utilized for this purpose, instead of mechanical alignment rods 38 and 40. In such an embodiment, computer system 89, including sensors and corresponding software, for example, may sense angle 26 of the optical device and a length of the optical device, along axis 14, from the object plane, conduct the required mathematical manipulations and then instruct the motors to move the plane of the CCD array and the plane of the objective lens so as to be coincident with a sheimpflug line. In particular, as an example of one set of mathematical manipulations that may be conducted to determine the correct angles 39 and 41 to ensure focus of the entire work piece plane, the following variables may be measured by the sensor system: the distance from sheimpflug point 67 to the center of work piece 18; the distance of lens 32 to work piece 18; the distance from lens 32 to image receiving device 28, and angle 26a between the work piece plane and the optical axis of the main body of the optical system. Of course, other variables may be sensed by the sensors, and other mathematical manipulations may be conducted in order to determine correct placement of the components to produce a focused view of the entire work plane. The proceeding variables are given merely as one example. In yet another embodiment, all three planes (CCD, lens and object planes) may each be manipulated so as to be coincident with a sheimpflug line.

FIG. 4 is an isometric schematic view of electronic image device 28, such as a CCD array, and objective lens 32 wherein optical axis 14, which extends through the array and the lens, is positioned at an oblique angle 26 with respect to object plane 16. Axis 40 and plane 37 of array 28 are positioned at an angle 41 with respect to horizontal axis 36 and plane 16 of the work piece. Axis 38 and plane 35 of lens 32 are positioned at an angle 39 with respect to horizontal axis 36 and plane 16 of the work piece. Work piece 18 is aligned with object plane 16 and includes three discrete objects 104, 106 and 108. As will be shown below with reference to FIG. 4, plane 16, plane 35 and plane 37 do not intersect at a single line. Accordingly, in this orientation the three planes do not define a Sheimpflug line. Therefore, the entire work piece 18 is not in focus on array 28. The device of the present invention provides alignment of plane 35, plane 37 and plane 16 so as to avoid the misalignment and resulting non-focused image created by the non-coincident positioning of the planes shown in this figure.

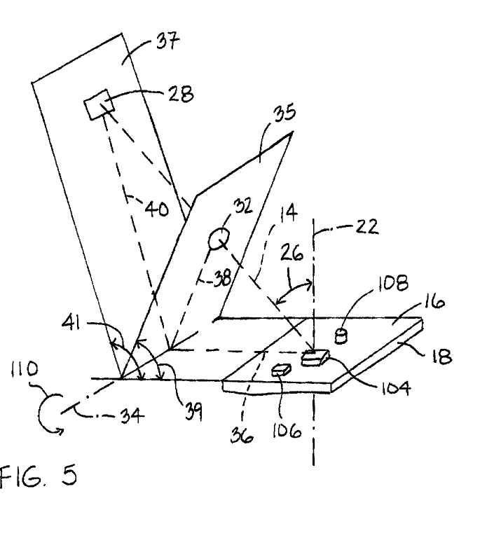

FIG. 5 is an isometric schematic view of the device of FIG. 4 wherein angle 41 of CCD array 28 with respect to the object plane and to axis 36 has been adjusted by moving the array about pivot point 50 (FIG. 3) in a direction 110. Accordingly, angle 41 in this figure has been increased with respect to angle 41 shown in FIG. 4. Movement of the plane of CCD array 28 has aligned axis 40 and plane 37 of the array with scheimpflug line 34 such that the entire work piece will be in focus on array 28, as shown in FIG. 8.

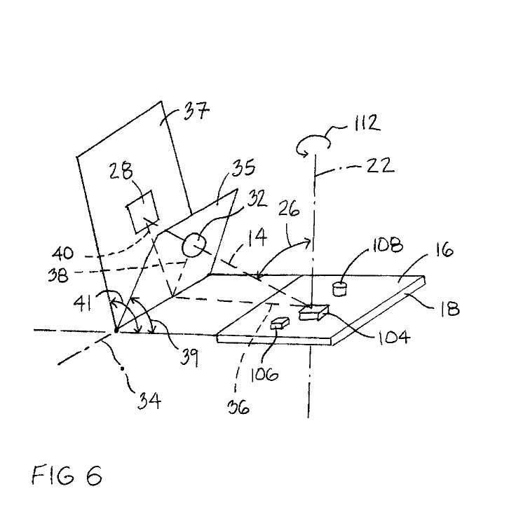

FIG. 6 is an isometric schematic view of the device of FIG. 5 wherein the plane of CCD array 28 and the plane of lens 32 have been rotated with respect to the object plane about axis 22 in a direction 112 and wherein optical device 12 has been moved downwardly thereby increasing angle 26. Accordingly, the view of the work piece shown on array 28 is of a different angle than the view of the work piece shown on the array of FIG. 5. However, the entire work piece will still be in focus on the array because planes 16, 35 and 37 all intersect at Sheimpflug line 34. As illustrated by these figures, an infinite number of Sheimpflug lines exist which will provide a focused image of the entire object plane.

FIG. 7 shows an image 114 displayed on the CCD array of FIG. 4, wherein only a portion 116 (indicated by the bracket as a central strip of the work piece) of work piece 18 is in focus. Discrete objects 106 and 108 are not positioned within portion 116 and, therefore, are out of focus in the image. Only strip 116 is in focus in this image because the plane 37 of CCD array 28 and the plane 35 of lens 32 are not aligned with one another to define a Sheimpflug line, as shown in FIG. 4.

FIG. 8 shows an image 118 displayed on the CCD array of FIG. 5, wherein the entire object plane is in focus, due to the angle-compensated adjustment capabilities of the present invention. Discrete objects 104, 106 and 108 are each in focus because the plane of CCD array 28 and the plane of lens 32 are each aligned with a Sheimpflug line 34, as shown in FIG. 5.

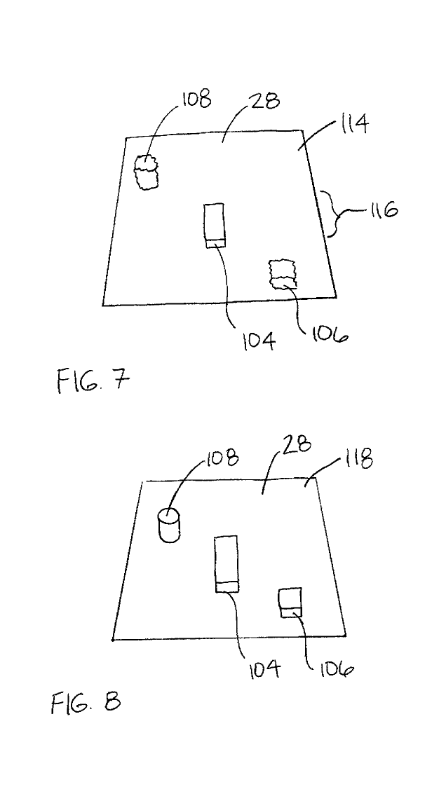

FIG. 9 shows an image 120 displayed on the CCD array of FIG. 6. In this image, the entire object plane is in focus because the plane of the CCD array and the plane of the objective lens are both aligned with a Sheimpflug line 34, as shown in FIG. 6. Due to the rotation of the array about axis 22 of the object plane, the image 120 shown in FIG. 9 of the work piece is a slightly different view than the image 118 shown in FIG. 8. Accordingly, objects 104, 106 and 108 on work piece 18 are viewed from a different angle than shown in FIG. 8.

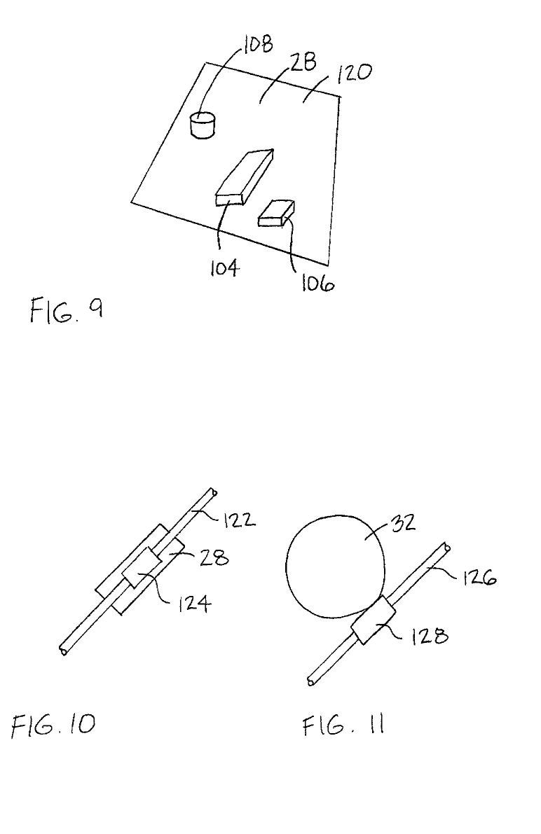

FIG. 10 shows an alternative embodiment of the alignment device for the charged coupled device array. In particular, the alignment device may comprise a rod 122 having a bushing 124 movably slidable therealong, wherein array 28 is secured to bushing 124. Accordingly, the alignment device need not comprise telescoping rods but instead may comprise any device that allows alignment of the plane of the CCD array, the plane of the objective lens and the plane of the object being viewed to be coincident at a Sheimpflug line.

FIG. 11 shows an alternative embodiment of the alignment device for the objective lens. In particular, the alignment device may comprise a rod 126 having a bushing 128 movably slidable therealong, wherein lens 32 is secured to bushing 128.

Accordingly, the present invention provides an optical system subject to a variety of movements designed to allow viewing of a full object plane in focus, from a variety of different directions. In particular, the system ensures the coincidence of the object plane, the lens plane and the image device plane along a Sheimpflug line so that the entire object plane is in focus on the image device, given the limitations of the coverage of the lens. In particular, the optical system includes an image receiving device 28 and an objective lens 32 that may each be tilted, i.e., rotated, about Sheimpflug line 67. The image receiving device and the lens may also swing about axes 40 and 38, respectively. The image receiving device and the lens may also be shifted along axes 40 and 38, respectively. Moreover, Sheimpflug line 67 may be moved along axis 36 toward or away from the work piece, and the entire system may be rotated about axis 22 to view the object plane from a variety of different directions. All of these movements are accomplished by the present invention while maintaining intersection of the object plane, the lens plane and the plane of the image receiving device so that the entire object plane is in focus.

In the above description numerous details have been set forth in order to provide a more through understanding of the present invention. It should be obvious, however, to one skilled in the art that the present invention may be practiced using other equivalent designs.

We claim:

1. An imaging system comprising:
an object plane that defines an object plane axis perpendicular to said object plane;
an image receiving device positioned oblique to said object plane axis;
a lens positioned oblique to said object plane axis, wherein said image receiving device and said lens are each positioned with respect to said object plane axis such that the entire object plane is in focus on said image receiving device, and
wherein said image receiving device is chosen from the group consisting of an electronic image receiving device array and a microscope.

2. The system of claim 1 wherein a plane defined by said image receiving device, and a plane defined by said lens each intersect said object plane at a Sheimpflug line.

3. The system of claim 1 wherein said image receiving device and said lens are each pivotally positioned within a main body positioned oblique to said object plane axis.

4. The system of claim 3 wherein said main body is manually manipulated such that the entire object plane is in focus on said image receiving device.

5. The system of claim 1 further comprising a motor that manipulates said image receiving device and said lens such that the entire object plane is in focus on said image receiving device.

6. The system of claim 1 wherein said image receiving device and said lens are each adjustably positioned with respect to said object plane axis such that the entire object plane is in focus on said image receiving device.

7. The system of claim 3 wherein said main body defines an optical axis that extends from said main body to a point where said object plane axis intersects said object plane, wherein said object plane axis and said optical axis define an angle therebetween, and wherein said angle is greater than zero degrees and less than ninety degrees.

8. The system of claim 1 further comprising:
a track positioned in said object plane;
a main body that defines an optical axis positioned oblique to said object plane axis, wherein said image receiving device and said lens are each pivotally secured to said main body;
a first telescoping arm movably secured to said track at a first end and secured to said image receiving device at a second end thereof, wherein a viewing plane of said image receiving device is aligned with an elongate axis of said first telescoping arm;
a second telescoping arm movably secured to said track at a first end and secured to said lens at a second end thereof, wherein a central plane of said lens is aligned with an elongate axis of said second telescoping arm; and
a support arm for supporting said main body relative to said object plane,
wherein said first end of said first telescoping arm and said first end of said second telescoping arm are each adapted for pivotal movement around a common pivot axis.

9. The system of claim 8 further comprising a second support arm for supporting said main body relative to said object plane, a first motor for moving said main body with respect to said support arm, a second motor for moving said support arm relative to said second support arm, a third motor for moving said second support arm with respect to said object plane, and a focusing device for moving said lens with respect to said main body along said optical axis.

10. A method of focusing an entire object plane, comprising the steps of:
providing an image receiving device along an optical axis positioned oblique to an object plane, wherein said image receiving device is chosen from the group consisting of an electronic image receiving device and a microscope;
providing a lens along said optical axis;
positioning said image receiving device so that an image receiving plane of said image receiving device intersects said object plane at a Sheimpflug line, and positioning said lens so that a lens plane of said lens intersects said object plane at said Sheimpflug line, such that the entire object plane is in focus on said image receiving device.

11. The method of claim 10 wherein said step of positioning said image receiving device is conducted manually and wherein said step of positioning said lens is conducted manually.

12. The method of claim 10 further comprising:
providing a track positioned in said object plane;
providing a first alignment device movably secured to said track at a first end and secured to said image receiving device at a second end thereof, wherein said image receiving plane of said image receiving device is fixedly aligned with an elongate axis of said first alignment device; and
providing a second alignment device movably secured to said track at a first end and secured to said lens at a second end thereof, wherein said central plane of said lens is fixedly aligned with an elongate axis of said second alignment device, and wherein said first end of said first alignment device and said first end of said second alignment device are each adapted for pivoting around a common pivot axis.

13. The system of claim 10 further comprising providing a motor system for moving said image receiving device with respect to said object plane and for moving said lens with respect to said object plane.

14. The system of claim 10 wherein said image receiving device comprises a charged-coupled device array.

15. An optical device comprising:
an image receiving device adjustably positioned along an optical axis oblique to an object plane; and
a lens adjustably positioned along said optical axis,
wherein said image receiving device is chosen from the group consisting of an electronic image receiving device and a microscope.

16. The device of claim 15 wherein said image receiving device defines a plane that intersects said object plane such that the entire object plane is in focus on said image receiving device and wherein said lens defines a plane that intersects said object plane such that the entire object plane is in focus on said image receiving device.

17. The device of claim 15 wherein said optical device comprises a main body aligned with said optical axis and wherein said image receiving device and said lens are each pivotally secured to said main body.

18. The device of claim 15 further comprising:
a first alignment device movably secured in said object plane at a first end and secured to said image receiving device at a second end thereof, wherein a plane of said image receiving device is aligned with an elongate axis of said first alignment device; and
a second alignment device movably secured in said object plane at a first end and secured to said lens at a second end thereof, wherein a plane of said lens is aligned with an elongate axis of said second alignment device, and wherein said first end of said first alignment device and said first end of said second alignment device are coupled together so as to pivot about a common pivot axis.

19. The device of claim 15 including a computer system for automatically manipulating said image receiving device and said lens such that the entire object plane is in focus on said image receiving device.

20. The device of claim 15 wherein said object plane is adjustable with respect to said image receiving device and said lens such that the entire object plane is in focus on said image receiving device.

21. The system of claim 1 further comprising a first motor that manipulates said image receiving device and a second motor that manipulates said lens such that the entire object plane is in focus on said image receiving device.

22. The system of claim 1 further comprising a motor system for manipulating a position of said image receiving device and a position of said lens with respect to said object plane, and a computer system adapted for sensing a position of said image receiving device and a position of said lens with respect to said object plane and for controlling said motor system so as to manipulate a position of said image receiving device and a position of said lens such that the entire object plane is in focus on said image receiving device.

23. The system of claim 7 further comprising a motor system for manipulating a position of said image receiving device and a position of said lens with respect to said object plane, and a computer system adapted for sensing a position of said image receiving device and a position of said lens with respect to said object plane and for controlling said motor system so as to manipulate a position of said image receiving device and a position of said lens such that the entire object plane is in focus on said image receiving device, and wherein said computer system senses a position of said image receiving device by measuring said angle and by measuring a distance of said image receiving device from said object plane along said optical axis.

24. The method of claim 13 further comprising providing a computer system for controlling said motor system so that the entire object plane is in focus on said image receiving device.

25. The method of claim 24 wherein said computer system includes a position sensor for sensing a position of said image receiving device and a position of said lens with respect to said object plane.

26. An inspection device comprising:
a lens that defines a lens plane,
an electronic image receiving device that defines an electronic image receiving device plane, and
a workpiece that defines a work plane,
wherein said lens plane, said electronic image receiving device plane, and said work plane are aligned according to a Sheimpflug principle.

27. The device of claim 26 wherein a position of said lens and a position of said image receiving device are each manually manipulated with respect to said work plane.

28. The device of claim 26 wherein a first alignment arm is used to align said lens with respect to said work plane, and a second alignment arm is used to align said image receiving device with respect to said work plane.

29. The device of claim 26 further comprising a motor system for aligning said lens and said image receiving device, wherein said motor system includes a sensor for sensing angle information of a position of said lens with respect to said work plane and angle information of a position of said image receiving device with respect to said work plane to achieve alignment of the lens and the image receiving device according to the Sheimpflug principle.
